(19) United States
(12) Patent Application Publication
(10) Pub. No.: US 2024/0427293 A1
(43) Pub. Date: Dec. 26, 2024

(54) PULL-OUT PIECE MECHANISM

(71) Applicant: ROLEX SA, Geneva (CH)

(72) Inventors: Cédric Jacot, La Chaux-de-Fonds (CH); Pierre-Alain Graemiger, Trélex (CH); Sacha Maffioli, Veigy-Foncenex (FR)

(73) Assignee: ROLEX SA, Geneva (CH)

(21) Appl. No.: 18/740,878

(22) Filed: Jun. 12, 2024

(30) Foreign Application Priority Data
Jun. 20, 2023 (EP) 23180355.2

(51) Int. Cl. G04B 27/02; G04D 3/00

(52) U.S. Cl. CPC G04B 27/023; G04D 3/00

(57) ABSTRACT

The pull-out piece mechanism (100) for timepiece movement includes a pull-out piece (20) having a pull-out piece body (21) including a first part (21) with a connecting element (21a) connecting to a control member (10), such as a pull-out piece stud (21a), and a second part (22), the first part being attached to the second part and the first part being movable with respect to the second part between (i) a first position in which the connecting element (21a) is able to engage with the control member (10) and (ii) a second position in which the connecting element (21a) is not able to engage with the control member (10), and an elastic return member (40) designed to return the first part (21) to the first position.

### CROSS-REFERENCE TO RELATED APPLICATION

This application claims priority of European patent application No. EP23180355.2 filed Jun. 20, 2023, the content of which is hereby incorporated by reference herein in its entirety.

### BACKGROUND ART

The invention relates to a pull-out piece mechanism. The invention also relates to a timepiece movement comprising such a pull-out piece mechanism. The invention also relates to a timepiece comprising such a timepiece movement or such a pull-out piece mechanism. The invention also relates to a method for operating such a timepiece movement or such a timepiece. The invention also relates to methods for assembling and dismantling such a timepiece movement or such a timepiece.

Within a timepiece movement, a control member or a control stem is intended to allow for winding, correcting or setting various functions of the movement. In order to do that, the control stem collaborates with a setting lever or, more particularly, with a pull-out piece which is able to perform a number of functions, such as:
securing the control stem to the movement by means of a connecting element, such as a stud, belonging to the pull-out piece and engaged in a groove of the stem,
indexing the control stem in defined axial positions through collaboration between the pull-out piece and a pull-out piece spring,
controlling the position of the components of the mechanism according to the axial position of the control stem, so as to configure these in such a way as to allow actuation of the various winding, correcting or setting functions.

In order to be able to fit a movement into or remove a movement from a timepiece middle, it is necessary for the control stem to be able to be detached from the movement. In order to do that, the pull-out piece is generally disengaged by a watchmaker until such point as it is out of reach of the groove of the stem and the latter can be removed from the movement by the watchmaker.

This action entails moving the pull-out piece in the thickness of the movement and therefore requires free space above this pull-out piece, this space therefore not being able to be used for other systems of the movement.

In addition, this movement of the pull-out piece may be the root cause of various different malfunctions because the pull-out piece is liable to remain jammed entangled with or straddling some other components of the mechanism. In such instances, it is necessary for the movement to be removed from the case and potentially partially dismantled in order to re-establish correct operation of the movement.

In order to alleviate these problems, there are various dismantling or design strategies that are generally employed, such as:
requiring removal of the control stem to be performed in a defined position,
designing some components of the mechanism to be thick enough that the pull-out piece cannot straddle them.

These strategies introduce constraints in terms of functionality and of thickness.

Various documents of the prior art describe solutions enabling the control stem to be removed by acting only on the pull-out piece connecting element engaged in the stem. However, those solutions are unable to overcome all of the above-mentioned disadvantages. In particular, they do not allow the control stem to secure itself spontaneously to the movement as it is inserted.

Patent EP1353245B1 discloses a setting mechanism provided with a translationally mobile pull-out piece comprising a locking piece intended to collaborate with a groove of a control stem. The specific feature of that mechanism lies in the fact that the locking piece is provided with a slot with two wings which are capable of occupying two angular positions within the pull-out piece. Rotating the piece through one quarter of a turn provides a transition from a locked configuration to an unlocked configuration, and vice versa. In the locked configuration, the locking piece is arranged in such a way that the wings engage with the groove of the stem in order to secure the stem to the pull-out piece. In the unlocked configuration, the wings conform to the exterior contour of the stem in order to allow said stem to be removed.

Document CH8819A discloses a mechanism comprising a pull-out piece provided with a screw intended to collaborate with a groove of a control stem. In order to secure the control stem to the pull-out piece, the screw is screwed into the pull-out piece until its end is able to engage with the groove. Conversely, in order to be able to remove the control stem from the movement, the screw is unscrewed until its end is out of reach of the groove.

### SUMMARY OF THE INVENTION

The object of the invention is to provide a pull-out piece mechanism able to improve on the pull-out piece mechanisms known from the prior art. In particular, the invention proposes a pull-out piece mechanism that makes it possible to limit the amount of space required for its operation and facilitates the operations of assembling and dismantling it.

According to the invention, a pull-out piece mechanism is defined by point 1 below.
1. Pull-out piece mechanism for timepiece movement, the mechanism comprising:
   a pull-out piece comprising a pull-out piece body including a first part comprising a connecting element connecting to a control member, such as a pull-out piece stud, and a second part, the first part being attached to the second part and the first part being movable with respect to the second part between (i) a first position in which the connecting element is able to engage with the control member and (ii) a second position in which the connecting element is not able to engage with the control member, and
   an elastic return member designed to return the first part to the first position.

Embodiments of the pull-out piece mechanism are defined by points 2 to 10 below.
2. Pull-out piece mechanism according to the preceding point, characterized in that the second part comprises a first control element controlling a member of a timepiece movement and in that the first part or the second part comprises:
   a first element for indexing the pull-out piece, and/or
   a first element for guiding the pull-out piece relative to a frame of a timepiece movement.
3. Pull-out piece mechanism according to one of the preceding points, characterized in that the first part is movable, notably exclusively movable, relative to the second part, in a direction or a plane that is perpendicular or substantially perpendicular to a longitudinal axis of a control member.
4. Pull-out piece mechanism according to one of the preceding points, characterized in that the first and second parts are secured together in the first position, notably returned toward one another under the effect of the elastic return member which is intended to block one degree of freedom of a slideway connection connecting the first and second parts.
5. Pull-out piece mechanism according to the preceding point, characterized in that the axis of the slideway connection is parallel or substantially parallel to the axis of the first element for guiding the pull-out piece relative to a frame.
6. Pull-out piece mechanism according to point 4, characterized in that the axis of the slideway connection is perpendicular or substantially perpendicular to the axis of the first element for guiding the pull-out piece relative to a frame.
7. Pull-out piece mechanism according to points 4 to 6, characterized in that the slideway connection comprises a profile engaging with a complementary geometry belonging to the connecting element.
8. Pull-out piece mechanism according to one of points 4 to 6, characterized in that the slideway connection comprises two guide pins engaging with two bores.
9. Pull-out piece mechanism according to one of points 4 to 6, characterized in that the slideway connection comprises two oblong openings engaging with two pins.
10. Pull-out piece mechanism according to one of points 1 to 7, characterized in that the first part and the second part comprise portions set one into the other and in that the first part and/or the second part comprises the elastic return member, as a flexible zone or a blade, between the second part and the connecting element.

According to the invention, a timepiece movement is defined by point 11 below.
11. Timepiece movement comprising a pull-out piece mechanism according to one of the preceding points.

According to the invention, a timepiece is defined by point 12 below.
12. Timepiece, notably wristwatch, comprising:
   a timepiece movement according to the preceding point, and/or
   a mechanism according to one of points 1 to 10.

According to the invention, embodiments of an assembly method are defined by points 13 and 14 below.
13. Method for assembling a control member with a timepiece movement according to point 11 or with a timepiece according to point 12, the method comprising:
   an action of inserting the control member,
   as a consequence of the insertion action, a movement of the first part relative to the second part from the first position to the second position, in a first direction, and an action of retracting the connecting element from the control member, then a movement of the first part relative to the second part in a second direction the opposite of the first direction until the connecting element becomes engaged in a shaping of the control member and until the first part regains the first position in which the first part and the second part are secured together.
14. Method for assembling a control member with a timepiece movement according to point 11 or with a timepiece according to point 12, the method comprising:
   an action of moving the first part relative to the second part from the first position to the second position, in a first direction, and of keeping the first part in the second position,
   an action of inserting the control member,
   an action of elastic return of the first part to the first position in which the first part and the second part are secured together.

According to the invention, a disassembly method is defined by point 15 below.
15. Method for disassembling a control member from a timepiece movement according to point 11 or from a timepiece according to point 12, the method comprising:
   an action of moving the first part relative to the second part in a first direction, and of keeping the first part in the second position,
   an action of withdrawing the control member,
   an action of elastic return of the first part to the first position.

### BRIEF DESCRIPTION OF THE DRAWINGS

The appended drawings show, by way of examples, three embodiments of a timepiece according to the invention.

FIG. 1 is a view of a timepiece according to the invention.

FIG. 2 is a perspective view of a first embodiment of a pull-out piece mechanism, in which view first and second pull-out piece parts are in a first relative position.

FIG. 3 is a perspective view of the first embodiment of a pull-out piece mechanism, in which view first and second pull-out piece parts are in a second relative position.

FIG. 4 is a view from above of a pull-out piece according to the first embodiment.

FIG. 5 is a perspective view of the pull-out piece of FIG. 4, in which view the first and second pull-out piece parts are in the first relative position.

FIG. 6 is a perspective view of the pull-out piece of FIG. 4, in which view the first and second pull-out piece parts are in the second relative position.

FIG. 7 is a perspective view of a second embodiment of a pull-out piece mechanism, in which view first and second pull-out piece parts are in a first relative position.

FIG. 8 is a perspective view of the second embodiment of a pull-out piece mechanism, in which view first and second pull-out piece parts are in a second relative position.

FIG. 9 is a view from above of a pull-out piece according to the second embodiment.

FIG. 10 is a perspective view of the pull-out piece of FIG. 9, in which view the first and second pull-out piece parts are in the first relative position.

FIG. 11 is a perspective view of the pull-out piece of FIG. 9, in which view the first and second pull-out piece parts are in the second relative position.

FIG. 12 is a perspective view of a third embodiment of a pull-out piece mechanism, in which view first and second pull-out piece parts are in a first relative position.

FIG. 13 is a perspective view of the third embodiment of a pull-out piece mechanism, in which view first and second pull-out piece parts are in a second relative position.

FIGS. 14 and 15 are views from above of a pull-out piece according to the third embodiment.

FIG. 16 is a perspective view of the pull-out piece of FIGS. 14 and 15, in which view the first and second pull-out piece parts are in the first relative position.

FIG. 17 is a perspective view of the pull-out piece of FIGS. 14 and 15, in which view the first and second pull-out piece parts are in the second relative position.

### DETAILED DESCRIPTION OF PARTICULAR EMBODIMENTS

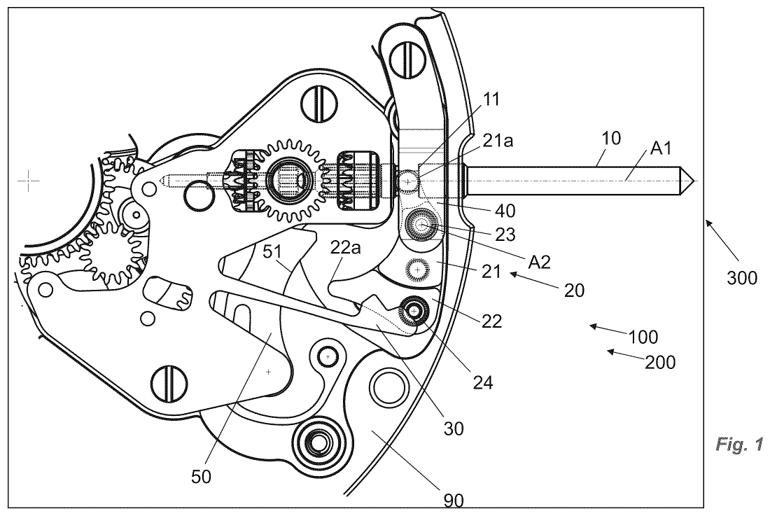

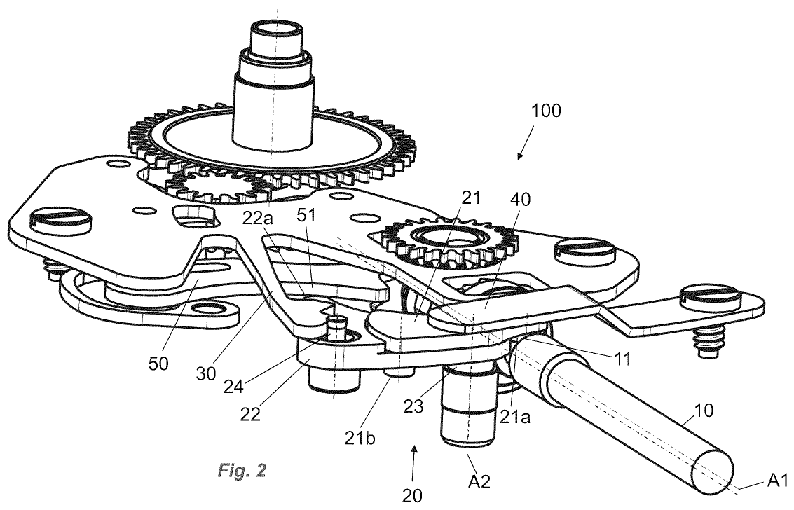

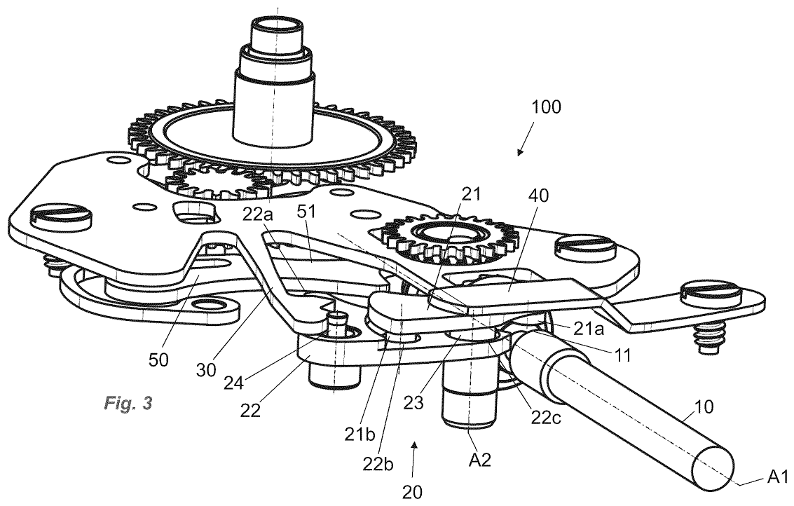

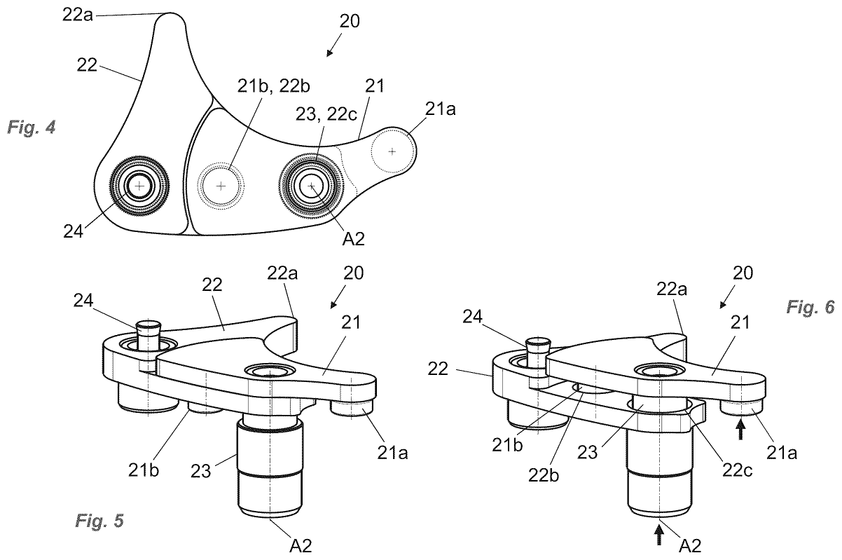

A first embodiment of a timepiece 300 is described below in detail with reference to FIGS. 1 to 6.

The timepiece 300 is for example a watch, in particular a wristwatch. The timepiece 300 comprises a timepiece movement 200 intended to be mounted in a timepiece casing or case in order to protect it from the external environment.

The timepiece movement 200 is a mechanical movement, notably an automatic movement, or a hybrid movement, or an electronic movement.

The timepiece movement 200 comprises a pull-out piece mechanism 100.

Whatever the embodiment, the pull-out piece mechanism comprises:
a pull-out piece comprising a pull-out piece body including a first part 21 comprising a connecting element 21a connecting to a control member 10, such as a pull-out piece stud, and a second part 22, the first part 21 being attached to the second part 22 and the first part 21 being movable with respect to the second part 22 between (i) a first position in which the connecting element 21a is able to engage with the control member 10 and (ii) a second position in which the connecting element 21a is not able to engage with the control member 10, and
an elastic return member designed to return the first part 21 to the first position.

The pull-out piece 20 allows the mechanism 100 to be configured according to the axial position of the control member 10, so as to allow actuation of the various horology functions, notably the winding, correcting or setting of the movement 200.

In the description that follows, one exemplary embodiment of a control member 10 is a control stem 10 movable in translation and in pivoting within a frame 90 of the movement 200, along and about an axis A1.

The pull-out piece 20 engages with the control stem 10 via the connecting element 21a that is intended to engage with a groove 11 machined on the control stem 10. In the description that follows, the connecting element 10 is a protruding shaping such as a stud.

The connecting element 21a of the pull-out piece 20 also allows the control stem 10 to be retained by the groove 11 inside the movement 200 or more particularly inside the frame 90.

The pull-out piece 20 is indexed in terms of its position by a pull-out piece spring 30, generally in two or three defined positions, which is to say that the two defined positions or two of the defined positions are stable positions of the pull-out piece with respect to the frame 90, these stable positions being separated by a continuum of unstable positions. As a result, the control stem 10 is also indexed, via the pull-out piece, by the pull-out piece spring 30, in said two or three positions, along the axis A1. The pull-out piece 20 is therefore notably able to perform:
a first function of securing the control stem 10 to the movement 200 via the connecting element 21a engaged in the groove 11 of the stem, and
a second function of controlling the position of at least one component 50 of the mechanism 100 according to the axial position of the control stem 10, so as to configure this component in such a way as to allow actuation of the various winding, correcting or setting functions.

In the embodiments described, each of said functions is performed by two distinct parts or components 21, 22 that the pull-out piece 20 comprises. The two parts 21, 22 are able to be moved relative to one another.

In this particular instance, the first part 21 is provided with the connecting element 21a able to engage with the groove 11 of the stem 10 and is able to perform the first function. The second part 22 is provided with at least one functional portion 22a, for example of the cam surface type, able to engage with at least one component 50 of the mechanism 100, such as a lever 50, so as to perform the second function. This functional portion 22a constitutes a control element.

Thanks to the solution, the first part 21 of the pull-out piece 20 is intended to be disengaged by a watchmaker in such a way that, in the second position, it is arranged out of reach of the control stem 10, without the second part 22 being stressed or moved relative to the frame 90.

Thus, when the connecting element 21a of the first part is arranged, in the second position, out of reach of the groove 11 of the stem, the pull-out piece 20 is said to be in an unlocked configuration. The unlocked configuration therefore allows the stem 10 to be withdrawn from the movement 200.

By contrast, when the connecting element 21a of the first part 21 is, in the first position, engaged in the groove 11 of the stem 10, the pull-out piece 20 is said to be in a locked configuration. The locked configuration therefore allows the actuation of the pull-out piece mechanism 100 by the control stem 10 and allows this stem to be held within the movement 200.

In the locked configuration, the first and second parts 21, 22 of the pull-out piece 20 are secured to one another such that the pull-out piece 20 behaves like a one-piece assembly and like a conventional pull-out piece for actuating the various functions of winding, correcting or setting the movement. In other words, in the locked configuration, the first and second parts 21, 22 of the pull-out piece 20 are arranged in such a way as to move together, in unison, when the stem 10 is actuated in the various positions.

Advantageously, the solution is designed in such a way that the pull-out piece 20 spontaneously reconfigures itself from the unlocked configuration to the locked configuration as a result of an elastic return of the first part 21 against the second part 22. This is brought about by the elastic return member 40 designed to return the first part 21 to the first position.

Advantageously also, the elastic return 40 of the first part 21 also allows the control stem 10 to be inserted into the movement 200 by retracting the connecting element 21a. As soon as the connecting element 21a has reached the groove 11, the pull-out piece 20 spontaneously reconfigures itself into the locked configuration under the effect of the elastic return, thus automatically securing the stem 10 to the movement 200.

More particularly, in the first embodiment, the pull-out piece 20 is pivoted on the frame 90 via a pin 23 about an axis A2 perpendicular to the axis A1 of the control stem 10. The pin 23 thus constitutes an element for guiding the pull-out piece. The collaboration between the pull-out piece 20 and the control stem 10 is achieved in such a way that a translational movement of the stem 10 along the axis A1 causes the pull-out piece 20 to rotate about the axis A2.

The first part 21 is assembled with the second part 22 while at the same time allowing movement according to a single degree of freedom in translation parallel to the axis A2. This assembly is embodied by the pin 23 and a tenon 21b both secured to the first part 21 and fitting into a respective one of two holes 22c and 22b which are formed in the second part 22. Once assembled on the first part 21, the shaping of the pin 23 prevents the two parts 21, 22 of the pull-out piece 20 from being disassembled. Thus, a slideway connection is formed through the use of two guide pins 21b, 23 collaborating with two bores 22b, 22c.

The second part 22 comprises a pull-out piece stud 24 intended to engage with the pull-out piece spring 30 so as to index the pull-out piece 20 in three defined angular positions about the axis A2.

Furthermore, the functional portion 22a of the second part 22 is capable of collaborating with a portion 51 of the lever 50 so as to actuate the various winding, correcting or setting functions.

In order to achieve the unlocked configuration and allow the control stem 10 to be withdrawn from the frame 90, a watchmaker simply needs to press axially on the pin 23, using a tool, so as to lift the first part 21, as depicted in FIG. 6, and disengage the connecting element 21a from the groove 11 of the stem 10. During this action, the second part 22 advantageously remains in place relative to the frame and is not lifted.

In this embodiment, the connecting element 21a is a stud 21a formed on or attached to the first part 21.

The elastic return of the first part 21 from the unlocked configuration to the locked configuration is performed by a pull-out piece thrust spring 40. The spring 40 provides an axial thrust, along the axis A2, that tends to keep the pull-out piece 20 in the locked configuration. This spring, presented here in the form of a spring blade, is preferably fixed to the frame 90 at one of its ends, for example using a screw.

In the conventional way, when the stem 10 is inserted into the movement 200, provision is made for it to be able to push back the stud 21a via a tapered or chamfered portion arranged ahead of the groove 11 on the stem 10. Thus, thanks to this shaping and to the elastic return of the first part 21, insertion of the stem 10 allows the transition of the pull-out piece 20 from the locked configuration to the unlocked configuration to occur automatically. As a result, as soon as the stud 21a has reached the groove 11, the stud drops spontaneously into the bottom of the groove as a result of the elastic restitution of the spring 40, thus once again configuring the pull-out piece 20 in the locked configuration.

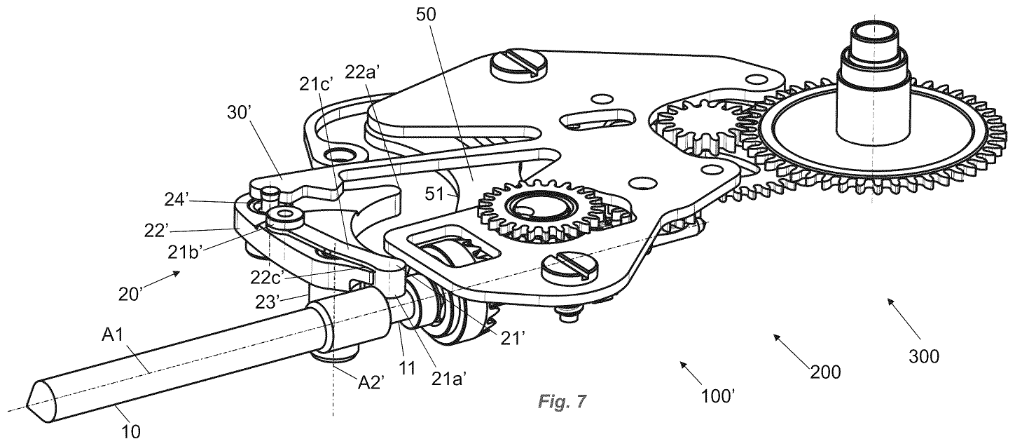

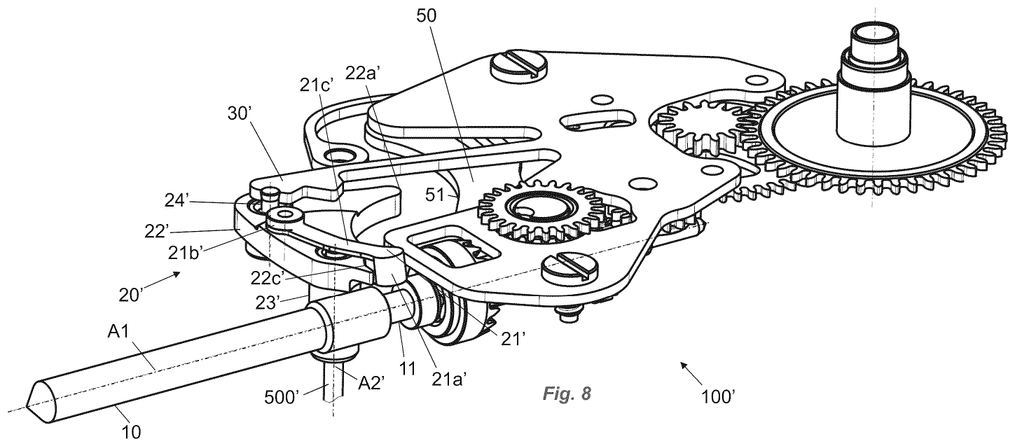

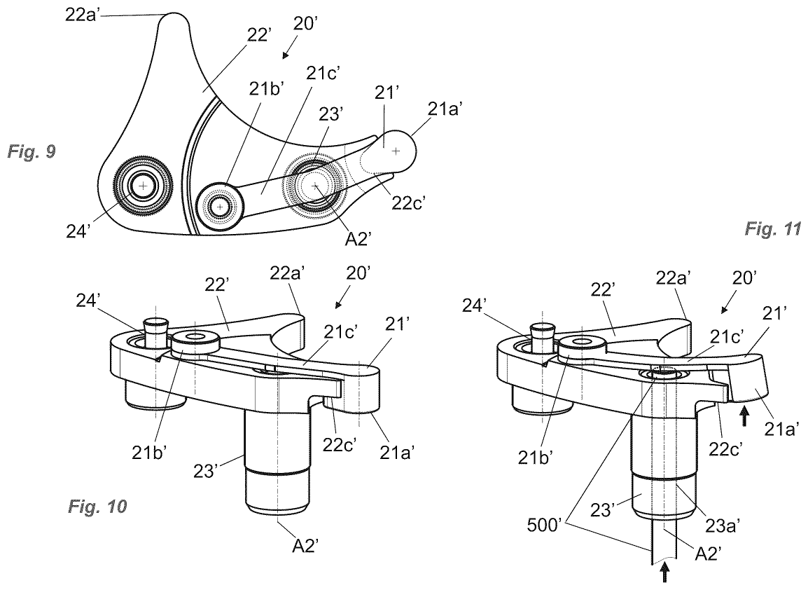

A second embodiment of a timepiece 300 is described below in detail with reference to FIGS. 7 to 11.

The timepiece 300 is for example a watch, in particular a wristwatch. The timepiece 300 comprises a timepiece movement 200 intended to be mounted in a timepiece casing or case in order to protect it from the external environment.

The timepiece movement 200 is a mechanical movement, notably an automatic movement, or a hybrid movement, or an electronic movement.

The timepiece movement 200 comprises a pull-out piece mechanism 100′.

In this second embodiment, the pull-out piece 20′ also pivots on the frame 90, via a pin 23′ that forms part of said pull-out piece, about an axis A2′ perpendicular to the axis A1 of the control stem 10. The pin 23′ thus constitutes an element for guiding the pull-out piece. The collaboration between the pull-out piece 20′ and the control stem 10 is achieved in such a way that a translational movement of the stem 10 along the axis A1 causes the pull-out piece 20′ to rotate about the axis A2′.

The pull-out piece 20′ comprises the first part 21′ and the second part 22′ forming a pull-out piece body. The pin 23′ here is secured to the second part 22′.

The first part 21′ consists of a flexible body 21c′ of which a portion is set into a portion of the second part 22′ or comprises a flexible part 21c′ of which a portion is set into the second part 22′ or into a portion of the second part 22′. The insetting may for example be achieved by means of a pin having a shoulder 21b′ that is driven into or welded in the second part 22′.

The free end of the flexible body 21c′ or of the flexible part 21c′ comprises a connecting element 21a′ that takes the form of a stud 21a′.

Thus, the first part 21′ and the second part 22′ comprise portions set one into the other. The first part and/or the second part comprise, by way of elastic return member 21c′, between the second part (22′) and the connecting element 21a′, the flexible part 21c′ or a blade 21c′.

The flexible body or the flexible part 21c′ is designed to be deformed chiefly in a direction parallel to the axis A2′ or substantially parallel to the axis A2′ so as to disengage the stud 21a′ from the groove 11 and configure the pull-out piece 20′ in the unlocked configuration. The movement of the stud 21a′ is in this instance (particularly on account of the length of the flexible part) likened to a translation parallel to the axis A2′.

As in the first embodiment, the second part 22′ comprises a pull-out piece stud 24′ intended to engage with a pull-out piece spring 30′ so as to index the pull-out piece 20′ in three defined angular positions.

In order for the stud 21a′ to have some rigidity when the stem 10 is actuated between the various defined axial positions of the mechanism, at least part of the periphery of the stud 21a′ is matched to a complementary shape or profile 22c′ machined on the second part 22′. This shape 22c′ constitutes a guide element for guiding or keeping the stud 21a′ substantially in a plane perpendicular to the axis A1. The collaboration between the shape 22c′ and the stud 21a′ can be likened to a slideway connection. Thus, only actuation in a direction substantially parallel to the axis A2′ is able to deform the flexible part 21c′ and move the stud 21a′.

In order to be able to withdraw the control stem 10 and bring the pull-out piece 20′ into the unlocked configuration, provision is made for a watchmaker to be able to press against the flexible part 21c′ using a tool 500′. For this, a hole 23a′ passing through the pin 23′, notably at its centre, or passing through another zone of the second part, is advantageously provided. This hole allows the tool 500′ to pass through.

As in the other embodiments, the pull-out piece 20′ advantageously returns spontaneously to the locked configuration by virtue here of the elastic return of the flexible part 21c′ which allows the connecting element 21a′ to become engaged spontaneously in the groove 11 of the stem 10.

The unlocking and the spontaneous or automatic locking of the pull-out piece 20′ upon the insertion of the control stem 10 are also ensured in this embodiment.

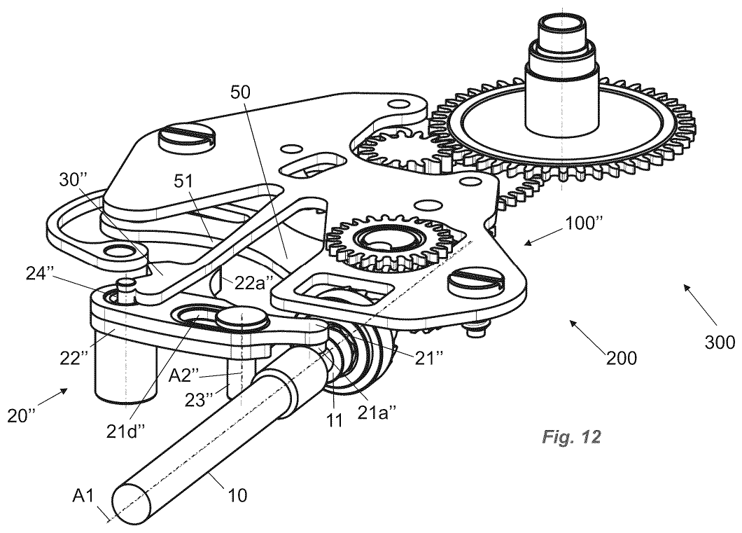

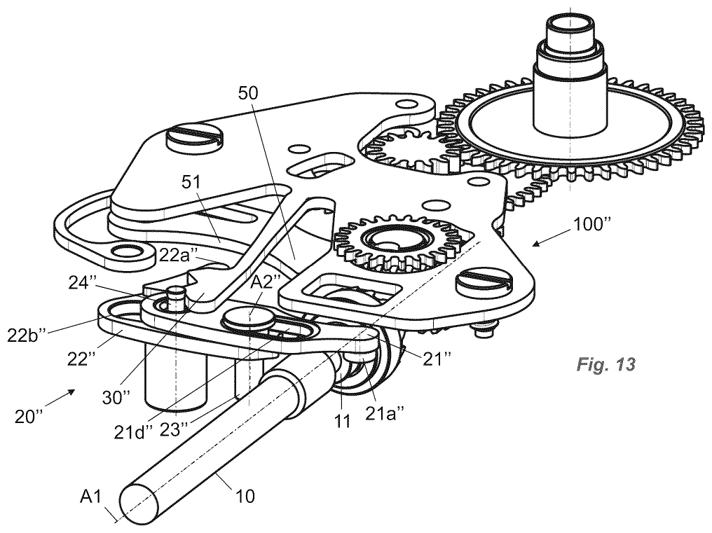

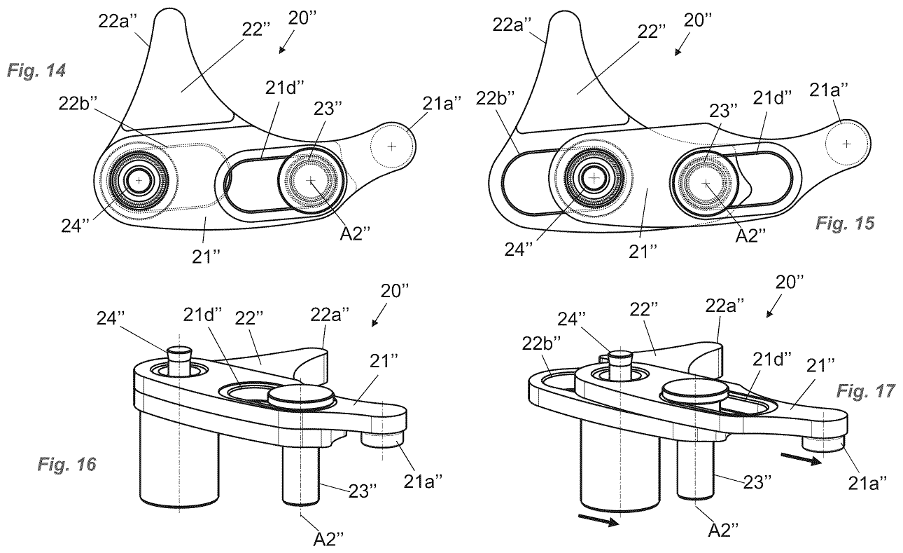

A third embodiment of a timepiece 300 is described below in detail with reference to FIGS. 12 to 17.

The timepiece 300 is for example a watch, in particular a wristwatch. The timepiece 300 comprises a timepiece movement 200 intended to be mounted in a timepiece casing or case in order to protect it from the external environment.

The timepiece movement 200 is a mechanical movement, notably an automatic movement, or a hybrid movement, or an electronic movement.

The timepiece movement 200 comprises a pull-out piece mechanism 100″.

In this third embodiment, the pull-out piece 20″ is also pivoted in the frame 90 via a pin 23″ about an axis A2″ perpendicular to the axis A1 of the control stem 10. The pin 23″ thus constitutes an element for guiding the pull-out piece.

The pull-out piece 20″ comprises the first part 21″ and the second part 22″ forming a pull-out piece body.

The specific feature of the third embodiment is that the pull-out piece 20″ is brought into the unlocked configuration by a substantially translational movement of the first part 21″ in a plane perpendicular to the axis A2″. For this, the first part comprises a first slideway 21d″ intended to engage with a pin having a shoulder 23″ driven into a second part 22″. In addition, the first part 21″ comprises a pull-out piece stud 24″ intended to engage with a second slideway 22b″ machined on the second part 22″. Of course, the first and second slideways 21d″, 22b″ are preferably oriented in the same direction. In this way there is formed a slideway connection comprising two oblong openings 21d″, 22b″ engaging with two pins 23″, 24″. The stud 24″ also allows indexing of the pull-out piece, by engaging with the pull-out piece spring 30″.

The first part 21″ also comprises a stud 21a″ intended to engage with the groove 11 of the stem.

In order to be able to configure the pull-out piece 20″ in the unlocked configuration, provision is therefore made for the stud 21a″ to disengage from the groove 11 of the stem from the side, namely in a direction that is orthoradial to the axis A1, namely substantially perpendicular to the axis A2″ and substantially perpendicular to the axis A1.

Thus, in order to be able to withdraw the control stem 10, provision is made for a watchmaker to be able, using a tool, to move the stud 24″ and the first pull-out piece part 21″ in a direction defined by the first and second slideways 21d″, 22b″ until the unlocked configuration is reached.

In this embodiment, the elastic return of the first part 21″ is provided directly by a pull-out piece spring 30″ which applies a force directed in such a way as to keep the pull-out piece 20″ in the locked configuration.

As in the previous two embodiments, provision is made for insertion of the control stem 10 into the movement to spontaneously configure the pull-out piece 20″ in the unlocked configuration and then, in the same action, as soon as the stud 21a″ has reached the groove 11 of the stem, to spontaneously configure it in the locked configuration.

As evidenced by the three embodiments presented, the elastic return of the first part 21, 21′, 21″ may notably be assured by a pull-out piece thrust spring 40, a flexible part 21c′ arranged within the pull-out piece or a pull-out piece indexing spring 30″. Nevertheless, more generally, the elastic return of the first part 21, 21′, 21″ or the spontaneous configuring of the pull-out piece 20, 20′, 20″ from the unlocked configuration to the locked configuration may be brought about by any elastic means intrinsic or extrinsic to the pull-out piece.

Of course, the proposed solution is also compatible with a pull-out piece intended to move linearly relative to the frame, as a result of an axial movement of the control stem.

In the three embodiments presented, the pull-out piece connecting element collaborating with the groove of the stem is arranged above the latter. Of course, said portion can also be arranged to the side of the groove. This alternative is incidentally particularly well suited to the third embodiment. The connecting element engaging with the groove of the stem could also be arranged below the latter.

As an alternative to the embodiments presented, in which the relative movement between the first and second parts during the transition from one configuration of the pull-out piece to the other is a translational movement, the relative movement between the first and second parts may be a rotational movement or a combined rotational and translational movement. This variant may be particularly well suited to the third embodiment.

Whatever the embodiment or variant, the control stem may be replaced by any other interface means capable of being held within a timepiece movement by a pull-out piece, such as a pushbutton.

Whatever the embodiment or variant, by extension, the pull-out piece may be a lever or a control of a mechanism.

Whatever the embodiment or variant, the first part or the second part may comprise:
a first element 24; 24′; 24″ for indexing the pull-out piece, and/or
a first element 23; 23′; 23″ for guiding the pull-out piece relative to a frame 90 of a timepiece movement 200.

That means that these elements may be provided on the one same part of the pull-out piece or on several different parts of the pull-out piece.

Whatever the embodiment or variant, the first and second parts are secured to one another in the first position. They may be returned toward one another under the effect of the elastic return member which is provided for blocking one degree of freedom of a slideway connection connecting the first and second parts.

The invention also relates to methods concerning such a pull-out piece mechanism.

In a first implementation of a method for assembling a control member 10 with a timepiece movement 200 described hereinabove or with a timepiece 300 (which is to say with a complementary assembly in order to constitute the timepiece) described hereinabove, the method comprises:
an action of inserting the control member 10,
as a consequence of the insertion action, a movement of the first part 21; 21′; 21″ relative to the second part 22; 22′; 22″ from the first position to the second position, in a first direction, and of retracting the connecting element 21a; 21a′; 21a″ from the control member 10, then a movement of the first part 21; 21′; 21″ relative to the second part 22; 22′; 22″ in a second direction the opposite of the first direction until the element for connection to the control member 10 becomes engaged in a shaping 11 of the control member 10 and until the first part regains the first position in which the first part and the second part are secured together.

In a second implementation of a method for assembling a control member 10 with a timepiece movement 200 described hereinabove or with a timepiece 300 (which is to say with a complementary assembly in order to constitute the timepiece) described hereinabove, the method comprises:
an action whereby a watchmaker moves the first part 21; 21′; 21″ relative to the second part 22; 22′; 22″ from the first position to the second position, in a first direction, and of keeping the first part in the second position,
an action of inserting the control member 10,
an action of elastic return of the first part 21; 21′; 21″ to the first position in which the first part and the second part are secured together.

In an implementation of a method for disassembling or of dismantling a control member 10 with respect to a timepiece movement 200 described hereinabove or with respect to a timepiece 300 described hereinabove, the method comprises:
an action of moving the first part 21; 21′; 21″ relative to the second part 22; 22′; 22″ in a first direction, and of keeping the first part in the second position,
an action of withdrawing the control member 10,
an action of elastic return of the first part to the first position.

In an implementation of a method of operation of a timepiece movement 200 described hereinabove or of a timepiece 300 described hereinabove, the method comprises:
an after-sales service phase, notably of assembly or disassembly, comprising implementation of a method described hereinabove, and
a routine-operation phase in which all the manipulations of the control member 10 that cause the first part 21; 21′; 21″ to move, cause the second part 22; 22′; 22″ to move as one therewith, as if the first and second parts were made as a single piece.

The solution described above offers advantages. Because the pull-out piece is produced in two parts, the functions can be separated. Specifically, the solution advantageously allows the part that provides for the securing of the control stem to be separated from the part that provides for the control of the various components of the mechanism. It thus makes it possible notably to overcome the known problems associated with the withdrawal of the control stem from the movement when the movement is being fitted into or removed from the timepiece.

Furthermore, the insertion of the control stem into the movement may be performed without the need for any particular action on the part of the watchmaker in order to secure it to the pull-out piece. Specifically, the solution described above makes it possible, again advantageously, for the pull-out piece to secure itself spontaneously to the control stem as the latter is being inserted into the movement.

According to the prior art, within a timepiece movement, the pull-out piece is generally located in the direct vicinity of the control stem, which means that the mechanism of the movement is also constructed close to this stem. In other words, the pull-out piece and the mechanism of the movement are generally arranged at a height similar to that of the control stem, in the thickness direction of the movement. Now, with the proposed solution, it is now possible to keep the first part of the pull-out piece in the direct vicinity of the control stem and to offset the second part of the pull-out piece in the heightwise direction, thus giving greater freedom as to the position of the mechanism within the thickness of the movement. Thus, by careful superposition of the two parts of the pull-out piece, it is possible to offset the stem heightwise in the thickness of the movement without altering the heightwise position of the mechanism of the movement, or, conversely, to offset the mechanism of the movement heightwise in the thickness of the movement without altering the heightwise position of the control stem.

1. A pull-out piece mechanism for timepiece movement, the mechanism comprising:
a pull-out piece comprising a pull-out piece body including a first part comprising a connecting element connecting to a control member, and a second part, the first part being attached to the second part and the first part being movable with respect to the second part between (i) a first position in which the connecting element is able to engage with the control member and (ii) a second position in which the connecting element is not able to engage with the control member, and
an elastic return member designed to return the first part to the first position.

2. The pull-out piece mechanism according to claim 1, wherein the second part comprises a first control element controlling a member of a timepiece movement, and wherein the first part or the second part comprises:
a first element for indexing the pull-out piece, and/or
a first element for guiding the pull-out piece relative to a frame of a timepiece movement.

3. The pull-out piece mechanism according to claim 1, wherein the first part is movable, notably exclusively movable, relative to the second part, in a direction or a plane that is perpendicular or substantially perpendicular to a longitudinal axis of a control member.

4. The pull-out piece mechanism according to claim 1, wherein the first and second parts are secured together in the first position, a slideway connection connecting the first and second parts.

5. The pull-out piece mechanism according to claim 4, wherein an axis of the slideway connection is parallel or substantially parallel to an axis of the first element for guiding the pull-out piece relative to a frame.

6. The pull-out piece mechanism according to claim 4, wherein an axis of the slideway connection is perpendicular or substantially perpendicular to an axis of the first element for guiding the pull-out piece relative to a frame.

7. The pull-out piece mechanism according to claim 4, wherein the slideway connection comprises a profile engaging with a complementary geometry belonging to the connecting element.

8. The pull-out piece mechanism according to claim 4, wherein the slideway connection comprises two guide pins engaging with two bores.

9. The pull-out piece mechanism according to claim 4, wherein the slideway connection comprises two oblong openings engaging with two pins.

10. The pull-out piece mechanism according to claim 1, wherein the first part and the second part comprise portions set into one another, and wherein the first part and/or the second part comprises the elastic return member, as a flexible zone or a blade, between the second part and the connecting element.

11. A timepiece movement comprising a pull-out piece mechanism according to claim 1.

12. A timepiece comprising a timepiece movement according to claim 11.

13. A method for assembling a control member with a timepiece movement, the method comprising:
providing the timepiece movement according to claim 1,
inserting the control member,
as a consequence of the inserting, causing a movement of the first part relative to the second part from the first position to the second position, in a first direction, and an action of retracting the connecting element from the control member, then a movement of the first part relative to the second part in a second direction opposite the first direction until the connecting element becomes engaged in a shaping of the control member and until the first part regains the first position in which the first part and the second part are secured together.

14. A method for assembling a control member with a timepiece movement, the method comprising:
providing the timepiece movement according to claim 1,
moving the first part relative to the second part from the first position to the second position, in a first direction, and keeping the first part in the second position,
inserting the control member,
causing elastic return of the first part to the first position in which the first part and the second part are secured together.

15. A method for disassembling a control member from a timepiece movement, the method comprising:
providing the timepiece movement according to claim 1,
moving the first part relative to the second part in a first direction, and keeping the first part in the second position,
withdrawing the control member,
causing elastic return of the first part to the first position.

16. The pull-out piece mechanism according to claim 1, wherein the control member is a pull-out piece stud.

17. The pull-out piece mechanism according to claim 2, wherein the first part is movable, notably exclusively movable, relative to the second part, in a direction or a plane that is perpendicular or substantially perpendicular to a longitudinal axis of a control member.

18. The pull-out piece mechanism according to claim 1, wherein the first and second parts are secured together in the first position.

19. The pull-out piece mechanism according to claim 4, wherein the first and second parts are returned toward one another under the effect of the elastic return member which is intended to block one degree of freedom of the slideway connection connecting the first and second parts.

20. The pull-out piece mechanism according to claim 5, wherein an axis of the slideway connection is perpendicular or substantially perpendicular to an axis of the first element for guiding the pull-out piece relative to a frame.
